(19) United States
(12) Patent Application Publication
(10) Pub. No.: US 2014/0099055 A1
(43) Pub. Date: Apr. 10, 2014

(54) Single-Fiber Bi-Directional Optical Transceiver

(71) Applicants: Hong-Yuan CHEN, Chengdu (CN); Yifan HSIEH, Chengdu (CN)

(72) Inventors: Hong-Yuan CHEN, Chengdu (CN); Yifan HSIEH, Chengdu (CN)

(21) Appl. No.: 13/717,596

(22) Filed: Dec. 17, 2012

(30) Foreign Application Priority Data
Oct. 9, 2012 (CN) 201210379294.4

(51) Int. Cl. G02B 6/12

(52) U.S. Cl. CPC G02B 6/12004
USPC 385/33

(57) ABSTRACT

A single-fiber bi-directional optical transceiver includes a bi-directional optical subassembly (BOSA) body and a fiber connecting sleeve connected to the BOSA body. The BOSA body contains a laser diode, a photodiode in a photodiode housing, and a splitter. The fiber connecting sleeve contains a connecting ferrule. A band pass filter is between the splitter and the photodiode, and the photodiode, band pass filter and reflection path of the splitter are coaxial and/or in series. Also, a coupling lens is between the splitter and the connecting ferrule, and the laser diode, splitter, coupling lens and connecting ferrule are coaxial and/or in series. In the single-fiber bi-directional optical transceiver, no fiber stub is present, thereby reducing the cost and/or size of the transceiver. By providing a coupling lens between the splitter and the connecting ferrule, the size of the BOSA body can be further reduced, thereby realizing a smaller package size.

### CROSS REFERENCE TO RELATED APPLICATIONS

This application claims the benefit of Chinese Patent Application No. 201210379294.4, filed on Oct. 9, 2012, which is incorporated herein by reference in its entirety.

### FIELD OF THE INVENTION

The invention relates to the field of fiber optical communication, in particular to a single-fiber bi-directional optical transceiver and method(s) of making and/or using the same.

### DISCUSSION OF THE BACKGROUND

A bi-directional optical subassembly (BOSA) is an optical transceiver assembly capable of converting electrical signals into optical signals or optical signals into electrical signals. FIG. 1 is a structural diagram showing a conventional BOSA 5, comprising a BOSA body 10, a laser diode 11, a photodiode 26 in a photodiode housing 12, a band pass filter 14 and a connecting ferrule 21. A coupling lens 22 is provided between the photodiode 26 and the band pass filter 14. A splitter 13 is between the laser diode 11 and the connecting ferrule 21. The photodiode 26, the band pass filter 14 and the reflection path 25 of the splitter 13 are coaxial and in series, while the laser diode 11, the splitter 13, the coupling lens 22 and the connecting ferrule 21 are coaxial and in series. As limited by the curve radius and refractive index of the coupling lens 22, the distances between the photodiode 26 and the coupling lens 22, the coupling lens 22 and the splitter 13, and the splitter 13 and the coupling face 30 of the fiber 23 are shortened. Optical reference surface 40 is an end face of the connecting ferrule 21 closest to the splitter 13. Furthermore, as the distance between optical reference surface 40 of the connecting ferrule 21 and photodiode 26 is restricted by standard connecter design, a fiber stub 28 configured to extend the position of the coupling face 30 must be provided between the connecting ferrule 21 and the splitter 13. That is, the coupling face 30 is on one end face of the fiber connector 29 closest to the splitter 13. The usage of fiber connector 29 and/or fiber stub 28 increases the production cost of the BOSA 5.

### SUMMARY OF THE INVENTION

The invention is intended to provide a single-fiber bi-directional optical transceiver without a fiber connector and/or stub, thereby reducing the cost of the bi-directional optical subassembly (BOSA), as well as realizing a simpler and relatively small or miniaturized structure.

In order to realize the above-mentioned objectives, the present invention provides a single-fiber bi-directional optical transceiver comprising a BOSA body and a fiber connecting sleeve connected to the BOSA body. The BOSA body contains a laser diode, a photodiode in a photodiode housing and a splitter. The fiber connecting sleeve contains a connecting ferrule. A band pass filter is placed between the splitter and the photodiode, and the photodiode, the band pass filter and the reflection path of the splitter are coaxial and/or in series. Also, a coupling lens is between the splitter and the connecting ferrule, and the laser diode, the splitter, the coupling lens and the connecting ferrule are coaxial and/or in series. Furthermore, the photodiode may be a planar photodiode.

In accordance with one embodiment of the present invention, an O-type shaft sleeve is provided between the fiber connecting sleeve and the connecting ferrule.

In accordance with another embodiment of the present invention, the splitter tilts relative to the optical path (e.g., between the laser diode and the end face of the fiber).

In accordance with another embodiment of the present invention, one side or surface of the splitter relative to or facing the laser diode has an antireflection film thereon.

In accordance with another embodiment of the present invention, one side or surface of the splitter relative to or facing the photodiode has a reflection-enhancing film thereon.

In accordance with another embodiment of the present invention, an optical signal from the fiber is provided to the splitter by the coupling lens, and is then transmitted to the band pass filter by the splitter. Finally, the band pass filter provides the signal to be absorbed by the photodiode.

In accordance with another embodiment of the present invention, an optical signal from the laser diode (converted from an electrical signal to the laser diode) is transmitted to the coupling lens through the splitter, focused by the coupling lens, and then provided to the fiber.

Relative to existing technologies, advantage(s) of the present invention include omitting a fiber connector and/or fiber stub from the conventional single-fiber bi-directional optical transceiver, so that the cost of the fiber connector and/or stub can be eliminated.

The fiber connecting sleeve accurately works with an O-type shaft sleeve, thereby preventing the fiber from losing its efficiency due to “wiggle” loss. In the field, “wiggle” can refer to problems with the alignment of optical fibers. This can occur during installation or when optical fibers or cabling are disturbed. Several dB of light power can be lost, which can be enough for an optical system to fail under certain circumstances.

Providing a coupling lens between the splitter and the connecting sleeve can minimize the distances between the photodiode and the band pass filter, between the band pass filter and the splitter, and/or between the splitter and the fiber, thereby reducing the size of the BOSA body. Also, the use of a planar photodiode reduces or eliminates part(s) of the photodiode housing that may protrude from the BOSA body, thereby realizing a smaller package size.

### BRIEF DESCRIPTION OF THE DRAWINGS

FIG. 1 is a structure diagram showing a conventional single-fiber bi-directional optical transceiver.

FIG. 2 is a structure diagram showing a single-fiber bi-directional optical transceiver in accordance with the present invention.

Labels in figures are as follows: 10-BOSA body, 11-laser diode, 12-photodiode housing, 13-splitter, 14-band pass filter, 20-fiber optic connecting sleeve, 21-connecting ferrule, 22-coupling lens, 23-optical fiber, 24-O-type shaft sleeve, 25-reflection path, 26-photodiode, 27-optical path, 28-fiber stub, 29-fiber connector, 30-fiber optic coupling surface, and 40-BOSA optical reference surface.

### DETAILED DESCRIPTION

The technical proposal(s) of embodiments of the present invention will be fully and clearly described in conjunction with the drawings in the following embodiments. It will be understood that the descriptions are not intended to limit the invention to these embodiments. On the contrary, the invention is intended to cover alternatives, modifications and equivalents that may be included within the spirit and scope of the invention as defined by the appended claims. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures, components, and circuits have not been described in detail so as not to unnecessarily obscure aspects of the present invention. The embodiments described here are only used to explain, rather than limit, the invention.

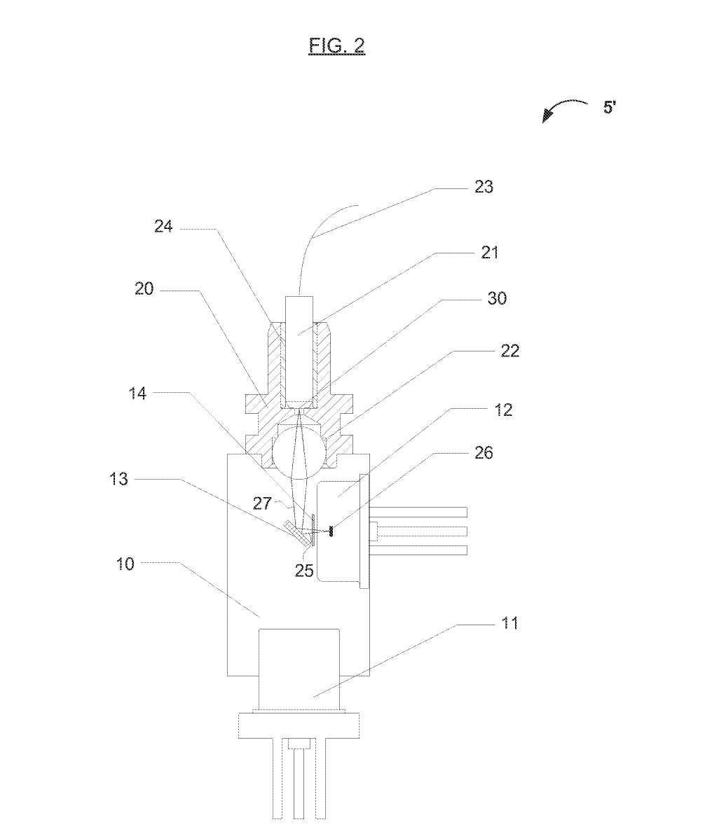

Referring to FIG. 2, an exemplary single-fiber bi-directional optical transceiver 5′ of the present invention comprises BOSA body 10 and fiber connecting sleeve 20 connected to BOSA body 10. BOSA body 10 contains laser diode 11, photodiode 26 in photodiode housing 12, and splitter 13. Photodiode 26 may be a planar photodiode. Splitter 13 is positioned at an angle of 45° relative to the optical path from the laser diode 11 and the coupling lens 22. Fiber connecting sleeve 20 contains connecting ferrule 21 configured to connect optical fiber 23. O-type shaft sleeve 24 is provided between connecting sleeve 20 and connecting ferrule 21, while coupling lens 22 is provided between splitter 13 and connecting ferrule 21. Laser diode 11, splitter 13, coupling lens 22 and connecting ferrule 21 are coaxial and/or in series. Band pass filter 14 is provided between splitter 13 and photodiode 26. Also, photodiode 26 and band pass filter 14 may share the same optical axis with the reflection path of splitter 13 and/or be in series.

A side or surface of splitter 13 facing laser diode 11 may have an antireflection film 31 thereon, configured to create destructive interference between incident light reflected by surfaces above and/or below the antireflection film 31, thereby reducing reflected luminous energy and increasing transmitted luminous energy. A side or surface of splitter 13 facing photodiode 26 may have a reflection-enhancing film 32 thereon, configured to superpose light reflected by each surface of the reflection-enhancing film 32.

In the exemplary embodiment of FIG. 2, the receive path is an optical signal from fiber 23 that is provided to splitter 13 via coupling lens 22, reflected to band pass filter 14 via splitter 13, and then is absorbed by photodiode 26 after being filtered by band pass filter 14, realizing optical signal reception.

In the exemplary embodiment of FIG. 2, the transmit path is an optical signal from laser diode 11 (converted from an electrical signal to laser diode 11) that is transmitted to coupling lens 22 via splitter 13, and then provided to fiber 23 after being focused by coupling lens 22, realizing optical signal transmission.

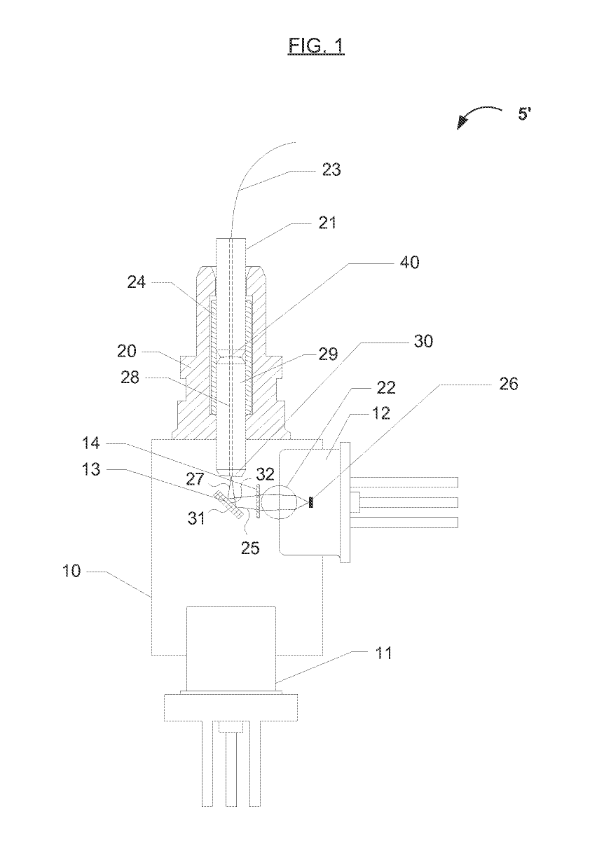

In the single-fiber bi-directional optical transceiver of the present invention, by modifying the curvature radius and refractive index of coupling lens 22, and by the usage of a planar photodiode, the distances between photodiode 26 and band pass filter 14, between band pass filter 14 and splitter 13, and/or between splitter 13 and connecting ferrule 21 can be changed such that coupling lens 22 can be positioned between connecting ferrule 21 and splitter 13. In addition, the fiber coupling surface 30 can overlap or be the same as the BOSA optical reference surface 40 (FIG. 1). Furthermore, both fiber coupling surface 30 and BOSA optical reference surface 40 are on an end face of connecting ferrule 21 close or closest to splitter 13.

When the present single-fiber bi-directional optical transceiver meets or complies with a standardized connector design structure, the fiber connector and/or stub (e.g., fiber connector 29 and fiber stub 28 in FIG. 1) are no longer present, and the cost of the fiber connector and/or stub is thus eliminated. Fiber connecting sleeve 20 accurately works with an O-type shaft sleeve 24, thereby preventing the fiber 23 from losing its efficiency due to “wiggle” loss. The O-type shaft sleeve 24 can be ceramic. Also, the stability and accuracy of the inner bore finish size, roundness and vertical dimension of the O-type shaft sleeve 24 can be relatively high and consistent. For example, the inner bore tolerance is typically less than 0.001 mm.

As shown in a comparison of FIGS. 1 and 2, providing coupling lens 22 between splitter 13 and connecting sleeve 21 can minimize the distances between photodiode 26 and band pass filter 14, between band pass filter 14 and splitter 13, and/or between splitter 13 and connecting ferrule 21, thereby reducing the size of the BOSA body 10. Also, the usage of a planar photodiode for photodiode 26 reduces the size and/or volume of one or more part(s) in photodiode housing 12 that may protrude from BOSA body 10, thereby realizing a smaller package size.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. An optical transceiver, comprising:
a bi-directional optical sub assembly (BOSA) body comprising a laser diode, a photodiode and a splitter;
a fiber connecting sleeve connected to the BOSA body, the fiber connecting sleeve configured to receive and/or at least partially enclose a connecting ferrule;
a band pass filter between the splitter and the photodiode such that the photodiode, the band pass filter and a reflection path of the splitter are coaxial and/or in series; and
a coupling lens between the splitter and the connecting ferrule such that the laser diode, the splitter, the coupling lens and the connecting ferrule are coaxial and/or in series.

2. The transceiver of claim 1, wherein the photodiode is a planar photodiode.

3. The transceiver of claim 1, further comprising an O-type shaft sleeve in the fiber connecting sleeve, the O-type shaft sleeve configured to receive and/or at least partially enclose the connecting ferrule.

4. The transceiver of claim 1, wherein the splitter tilts relative to an optical path from the laser diode to an end face of the connecting ferrule.

5. The transceiver of claim 4, wherein the splitter is at a 45° angle relative to the optical path.

6. The transceiver of claim 4, wherein a first side of the splitter facing the laser diode has an antireflection film thereon.

7. The transceiver of claim 6, wherein a second side of the splitter facing the photodiode has a reflection-enhancing film thereon.

8. The transceiver of claim 1, wherein a received optical signal passes to the splitter through the coupling lens, then from the splitter through the band pass filter to the photodiode, and the band pass filter filters the received optical signal.

9. The transceiver of claim 8, wherein the laser diode receives an electrical signal and transmits a transmitted optical signal to an optical fiber in the connecting ferrule through the splitter and the coupling lens, and the coupling lens focuses the transmitted optical signal.

10. The transceiver of claim 1, wherein the photodiode, the band pass filter and the reflection path of the splitter share a common optical axis.

11. The transceiver of claim 1, wherein a first side or surface of the splitter facing the laser diode comprises an antireflection film thereon.

12. The transceiver of claim 1, wherein a second side or surface of the splitter facing the photodiode comprises a reflection-enhancing film thereon.

13. A method of communicating one or more optical signals, comprising:
receiving an incoming optical signal from an optical fiber;
passing the incoming optical signal through a connecting ferrule configured to optically connect the optical fiber to a coupling lens;
reflecting the incoming optical signal from the coupling lens to a filter using a splitter;
filtering the incoming optical signal through the filter;
absorbing the incoming optical signal with a photodiode;
transmitting an outgoing optical signal from a laser diode through the splitter;
focusing the outgoing optical signal using the coupling lens; and
providing the outgoing optical signal to the optical fiber.

14. The method of claim 13, wherein the splitter is at a 45° angle relative to an optical path of the incoming optical signal.

15. The method of claim 13, wherein the photodiode, the filter and a reflection path of the splitter share a common optical axis.

16. The method of claim 13, further comprising positioning the coupling lens between the connecting ferrule and the splitter.

17. The method of claim 16, wherein positioning the coupling lens comprises selecting a curvature radius and/or a refractive index of the coupling lens that is proper or appropriate for a position of the coupling lens between the connecting ferrule and the splitter.

18. The method of claim 17, wherein the photodiode is a planar photodiode.

19. The method of claim 13, wherein the splitter further comprises an antireflection film on a first side or surface configured to receive the outgoing optical signal.

20. The method of claim 13, wherein the splitter further comprises a reflection-enhancing film on a second side or surface configured to receive the incoming optical signal.
